(19) United States
(12) Patent Application Publication
(10) Pub. No.: US 2019/0233923 A1
(43) Pub. Date: Aug. 1, 2019

(54) ROD, DRILL BIT BODY, ROD MANUFACTURING METHOD, AND DRILL MANUFACTURING METHOD

(71) Applicant: SUMITOMO ELECTRIC HARDMETAL CORP., Itami-shi (JP)

(72) Inventors: Takahiro Yamakawa, Itami-shi (JP); Eiji Yamamoto, Itami-shi (JP); Hiroaki Gotou, Itami-shi (JP); Yoshimitsu Sawazono, Itami-shi (JP); Katsuya Uchino, Itami-shi (JP)

(21) Appl. No.: 16/307,212

(22) PCT Filed: Feb. 28, 2017
(86) PCT No.: PCT/JP2017/007732

§ 371 Date: Dec. 5, 2018

(30) Foreign Application Priority Data
Jun. 6, 2016 (JP) 2016-112669

(51) Int. Cl. C22C 29/08; B22F 3/16; B22F 5/00; B23B 51/02

(52) U.S. Cl. CPC C22C 29/08; B22F 3/162; B22F 5/00; B23B 2222/28; B22F 2005/001; B22F 2301/15; B22F 2302/10; B23B 51/02

(57) ABSTRACT

A rod includes a first rod section occupying a predetermined region in a longitudinal direction, and a second rod section occupying a region different from the first rod section in the longitudinal direction. The first rod section has composition including A% by mass of cobalt, 0 to 1% by mass of chromium, 0 to 0.5% by mass of vanadium, and remainder of tungsten carbide and unavoidable impurities. The second rod section has composition including B% by mass of cobalt, 0 to 1% by mass of chromium, 0 to 0.5% by mass of vanadium, and remainder of tungsten carbide and unavoidable impurities. Contents of cobalt in the first rod section and the second rod section satisfy a relationship of 1% by mass≤B<A≤20% by mass. The second rod section has a length of 10 to 1000% with respect to the first rod section in the longitudinal direction.

### TECHNICAL FIELD

The present invention relates to a rod, a drill bit body, a rod manufacturing method, and a drill manufacturing method. This application claims priority based on Japanese Patent Application No. 2016-112669 filed on Jun. 6, 2016. All descriptions described in the Japanese patent application are incorporated in this specification by reference.

### BACKGROUND ART

Conventionally, a small drill called a miniature drill or a micro drill is used for the purpose of drilling a printed board of a semiconductor device or the like. Japanese Patent Laying-Open No. 2002-346816 (PTL 1) discloses a cemented carbide miniature drill that is said to exhibit excellent abrasion resistance in high-speed drilling processing. Furthermore, Japanese Patent Laying-Open No. 2004-160591 (PTL 2) discloses a micro drill having both breakage resistance and abrasion resistance.

### CITATION LIST

### Patent Literature

PTL 1: Japanese Patent Laying-Open No. 2002-346816
PTL 2: Japanese Patent Laying-Open No. 2004-160591

### SUMMARY OF INVENTION

A rod according to an aspect of the present invention includes a first rod section occupying a predetermined region in a longitudinal direction; and a second rod section occupying a region different from the first rod section in the longitudinal direction. The first rod section has composition including A% by mass of cobalt, 0 to 1% by mass of chromium, 0 to 0.5% by mass of vanadium, and remainder of tungsten carbide and unavoidable impurities. The second rod section has composition including B% by mass of cobalt, 0 to 1% by mass of chromium, 0 to 0.5% by mass of vanadium, and remainder of tungsten carbide and unavoidable impurities. Contents of cobalt in the first rod section and the second rod section satisfy a relationship of 1% by mass≤B<A≤20% by mass. The first rod section and the second rod section each include greater than or equal to 0.1% by mass of at least one of chromium and vanadium. The second rod section has a length of 10 to 1000% with respect to the first rod section in the longitudinal direction.

A drill bit body according to an aspect of the present invention is a drill bit body including the rod. The drill bit body has a length of 0.5 to 15 mm, and has a maximum diameter in a cross section perpendicular to the longitudinal direction of 0.03 to 3.175 mm. The second rod section occupies a tip end of the drill bit body.

A rod manufacturing method according to an aspect of the present invention is a rod manufacturing method for manufacturing the rod. The rod manufacturing method includes a first step of preparing first powder having composition including A% by mass of cobalt, 0 to 1% by mass of chromium, 0 to 0.5% by mass of vanadium, and remainder of tungsten carbide and unavoidable impurities and second powder having composition including B% by mass of cobalt, 0 to 1% by mass of chromium, 0 to 0.5% by mass of vanadium, and remainder of tungsten carbide and unavoidable impurities; a second step of charging the first powder into a mold and pressing the first powder with a first pressure; and a third step of charging the second powder into the mold and pressing the second powder with a second pressure equal to or lower than the first pressure. Contents of cobalt in the first powder and the second powder satisfy a relationship of 1% by mass≤B<≤20% by mass. The first powder and the second powder each include greater than or equal to 0.1% by mass of at least one of chromium and vanadium.

A drill manufacturing method according to an aspect of the present invention is a drill manufacturing method for manufacturing a drill by using the rod. The drill manufacturing method includes an α step of determining a central axis by cutting the rod; and a β step of defining a groove on the rod with reference to the central axis.

### BRIEF DESCRIPTION OF DRAWINGS

FIG. 1A is a schematic diagram schematically showing an example of regions occupied by first to fourth rod sections in a longitudinal direction of a rod according to the present embodiment.

FIG. 1B is a schematic diagram schematically showing another example of regions occupied by the first to fourth rod sections in the longitudinal direction of the rod according to the present embodiment.

FIG. 1C is a schematic diagram schematically showing an example of regions occupied by first to fifth rod sections in the longitudinal direction of the rod according to the present embodiment.

FIG. 1D is a schematic diagram schematically showing another example of regions occupied by the first to fifth rod sections in the longitudinal direction of the rod according to the present embodiment.

FIG. 2 is a side view of a drill according to the present embodiment.

FIG. 3 is a cross sectional view taken along a line II-II in FIG. 2.

### DETAILED DESCRIPTION

### Problems to Be Solved by Present Disclosure

As also described in PTL 1 and PTL 2, a drill that can be used for high-speed processing is demanded for drilling a printed board of a semiconductor device or the like. Specifically, abrasion resistance based on sufficient hardness is demanded for the tip end portion of a drill bit body, and breakage resistance (so-called toughness) based on certain flexibility is demanded for a main body portion of the drill bit body. However, it is known that abrasion resistance and breakage resistance are generally contradictory physical properties, and although technological development for simultaneously achieving these physical properties is being made, there is room for improvement. Therefore, miniature drills or micro drills that can simultaneously achieve desired abrasion resistance and breakage resistance are not realized yet, and development thereof is strongly desired.

The present invention has been made in view of the above circumstances, and an object of the present invention is to provide a rod, a drill bit body, a rod manufacturing method, and a drill manufacturing method that realize both abrasion resistance and breakage resistance.

### Advantageous Effects of Present Disclosure

According to the above, it is possible to provide a rod that realizes both abrasion resistance and breakage resistance.

### DESCRIPTION OF EMBODIMENTS

First, embodiments of the present invention will be sequentially described.

[1] A rod according to an aspect of the present invention includes a first rod section occupying a predetermined region in a longitudinal direction; and a second rod section occupying a region different from the first rod section in the longitudinal direction. The first rod section has composition including A% by mass of cobalt, 0 to 1% by mass of chromium, 0 to 0.5% by mass of vanadium, and remainder of tungsten carbide and unavoidable impurities. The second rod section has composition including B% by mass of cobalt, 0 to 1% by mass of chromium, 0 to 0.5% by mass of vanadium, and remainder of tungsten carbide and unavoidable impurities. Contents of cobalt in the first rod section and the second rod section satisfy a relationship of 1% by mass≤B<≤20% by mass. The first rod section and the second rod section each include greater than or equal to 0.1% by mass of at least one of chromium and vanadium. The second rod section has a length of 10 to 1000% with respect to the first rod section in the longitudinal direction. With such a feature, when a rod is used, for example, for a drill bit body, abrasion resistance can be imparted to the tip end portion of the drill bit body, and breakage resistance can be imparted to the main body portion of the drill bit body.

[2] It is preferable that, in each of the first rod section and the second rod section, a total amount of chromium and vanadium is 0.2 to 1.5% by mass. As a result, when a rod is used, for example, for a drill bit body, abrasion resistance of the tip end portion of the drill bit body and breakage resistance of the main body portion of the drill bit body can be improved.

[3] It is preferable that the rod further includes a third rod section and a fourth rod section, the third rod section includes cobalt, chromium, vanadium, tungsten carbide, and unavoidable impurities, an average particle diameter of tungsten carbide in the third rod section is X μm, the fourth rod section includes cobalt, chromium, vanadium, tungsten carbide, and unavoidable impurities, an average particle diameter of tungsten carbide in the fourth rod section is Y μm, in the third rod section and the fourth rod section, the average particle diameters of tungsten carbide satisfy a relationship of X≤Y, the third rod section occupies a region that partially or entirely overlaps the first rod section in the longitudinal direction, the fourth rod section occupies a region that partially or entirely overlaps the second rod section in the longitudinal direction, and the fourth rod section has a length of 10 to 1000% with respect to the third rod section in the longitudinal direction. As a result, when a rod is used, for example, for a drill bit body, abrasion resistance of the tip end portion of the drill bit body can be improved, and breakage resistance of the main body portion of the drill bit body can be improved.

[4] It is preferable that the rod further includes a fifth rod section occupying a predetermined region between the first rod section and the second rod section in the longitudinal direction, the fifth rod section has composition including C% by mass of cobalt, 0 to 1% by mass of chromium, 0 to 0.5% by mass of vanadium, and remainder of tungsten carbide and unavoidable impurities, a content of cobalt in the fifth rod section satisfies a relationship of A≥C or C≥B, the fifth rod section includes greater than or equal to 0.1% by mass of at least one of chromium and vanadium, and the fifth rod section occupies a region that overlaps both or either one of the third rod section and the fourth rod section in the longitudinal direction. Also as a result of having this feature, when a rod is used, for example, for a drill bit body, abrasion resistance of the tip end portion of the drill bit body and breakage resistance of the main body portion of the drill bit body can be improved.

[5] A drill bit body according to an aspect of the present invention is a drill bit body including the rod. The drill bit body has a length of 0.5 to 15 mm, and has a maximum diameter in a cross section perpendicular to the longitudinal direction of 0.03 to 3.175 mm. The second rod section occupies a tip end of the drill bit body. With such a feature, a drill bit body can have abrasion resistance at the tip end portion of the drill bit body, and can have breakage resistance at the main body portion of the drill bit body.

[6] It is preferable that the drill bit body satisfies a relationship of 0.05R≤r≤0.6R when R represents the maximum diameter and r represents a web thickness in the cross section. As a result, it is possible to improve dischargeability of cutting chips.

[7] A rod manufacturing method according to an aspect of the present invention is a method for manufacturing the rod described above, and includes a first step of preparing first powder having composition including A% by mass of cobalt, 0 to 1% by mass of chromium, 0 to 0.5% by mass of vanadium, and remainder of tungsten carbide and unavoidable impurities and second powder having composition including B% by mass of cobalt, 0 to 1% by mass of chromium, 0 to 0.5% by mass of vanadium, and remainder of tungsten carbide and unavoidable impurities; a second step of charging the first powder into a mold and pressing the first powder with a first pressure; and a third step of charging the second powder into the mold and pressing the second powder with a second pressure equal to or lower than the first pressure. Contents of cobalt in the first powder and the second powder satisfy a relationship of 1% by mass≤B<A≤20% by mass. The first powder and the second powder each include greater than or equal to 0.1% by mass of at least one of chromium and vanadium. With such a feature, a rod can be manufactured that can, when used as, for example, a drill bit body, impart abrasion resistance to the tip end portion of the drill bit body, and impart breakage resistance to the main body portion of the drill bit body.

[8] It is preferable that, in each of the first powder and the second powder, a total amount of chromium and vanadium is 0.2 to 1.5% by mass. As a result, a rod can be manufactured that can, when used as, for example, a drill bit body, improve abrasion resistance of the tip end portion of the drill bit body and breakage resistance of the main body portion of the drill bit body.

[9] It is preferable that the rod manufacturing method further includes a fourth step of preparing third powder having composition including C% by mass of cobalt, 0 to 1% by mass of chromium, 0 to 0.5% by mass of vanadium, and remainder of tungsten carbide and unavoidable impurities; and a fifth step of charging the third powder into the mold and pressing the third powder with a third pressure equal to or lower than the first pressure and equal to or higher than the second pressure, a content of cobalt in the third powder satisfies a relationship of A≥C or C≥B, and the third powder includes greater than or equal to 0.1% by mass of at least one of chromium and vanadium. Also as a result of having this feature, a rod can be manufactured that can, when used for, for example, a drill bit body, improve abrasion resistance of the tip end portion of the drill bit body and breakage resistance of the main body portion of the drill bit body.

A drill manufacturing method according to an aspect of the present invention is a method for manufacturing a drill by using the rod. The drill manufacturing method includes an α step of determining a central axis by cutting the rod; and a β step of defining a groove on the rod with reference to the central axis. With such a feature, a drill can be manufactured in which a drill bit body can have abrasion resistance at the tip end portion of the drill bit body, and can have breakage resistance at the main body portion of the drill bit body.

[11] It is preferable that the drill manufacturing method further includes a γ step of attaching a shank to the rod before the α step. Abrasion resistance of the tip end portion of the drill bit body and breakage resistance of the main body portion of the drill bit body can be improved also by manufacturing such a drill.

### Details of Embodiment of Present Invention

Hereinafter, embodiments will be described. In the drawings used for the description of the embodiments below, the same reference signs denote the same parts or corresponding parts.

Here, in this specification, description in the form of “A to B” means the upper and lower limits of a range (that is, greater than or equal to A and less than or equal to B), and in the case where description of the unit is not given for A, and the description of the unit is given only for B, the unit of A is the same as the unit of B. In addition, in the present specification, when a compound or the like is represented by a chemical formula, when an atomic ratio is not particularly limited, it is assumed that all conventionally known atomic ratios are included, and the atomic ratio is not necessarily limited to those in the stoichiometric range.

<<Rod>>

A rod according to the present embodiment includes a first rod section occupying a predetermined region in the longitudinal direction, and a second rod section occupying a region different from the first rod section in this longitudinal direction. The first rod section has composition including A% by mass of cobalt, 0 to 1% by mass of chromium, 0 to 0.5% by mass of vanadium, and remainder of tungsten carbide and unavoidable impurities. The second rod section has composition including B% by mass of cobalt, 0 to 1% by mass of chromium, 0 to 0.5% by mass of vanadium, and remainder of tungsten carbide and unavoidable impurities. Particularly, contents of cobalt in the first rod section and the second rod section satisfy a relationship of 1% by mass≤B<≤20% by mass. The first rod section and the second rod section each include greater than or equal to 0.1% by mass of at least one of chromium and vanadium. The second rod section has a length of 10 to 1000% with respect to the first rod section in the longitudinal direction.

That is, the rod according to the present embodiment is made of cemented carbide or the like containing tungsten carbide (WC) as a hard phase and cobalt (Co) as a binder phase. The shape of the rod should not be particularly limited as long as it is a rod shape, but the rod is preferably a round rod in the case where use for a drill bit body described later is assumed.

For example, in the case where a rod is used for a drill bit body in which the second rod section is a tip end portion of the drill bit body that makes direct contact with a processing target object and performs drilling or the like and the first rod section is main body portion of the drill bit body that takes charge of discharging cutting chips or the like of the processing target object that has been generated at the tip end portion of the drill bit body, abrasion resistance can be imparted to the tip end portion of the drill bit body. It is possible to impart breakage resistance to the main body portion of the drill bit body. Therefore, when such a rod is used for a drill bit body, since it is possible to improve the breakage resistance and the abrasion resistance, it is possible to dramatically improve the number of processing in high-speed drilling processing.

<First Rod Section and Second Rod Section>

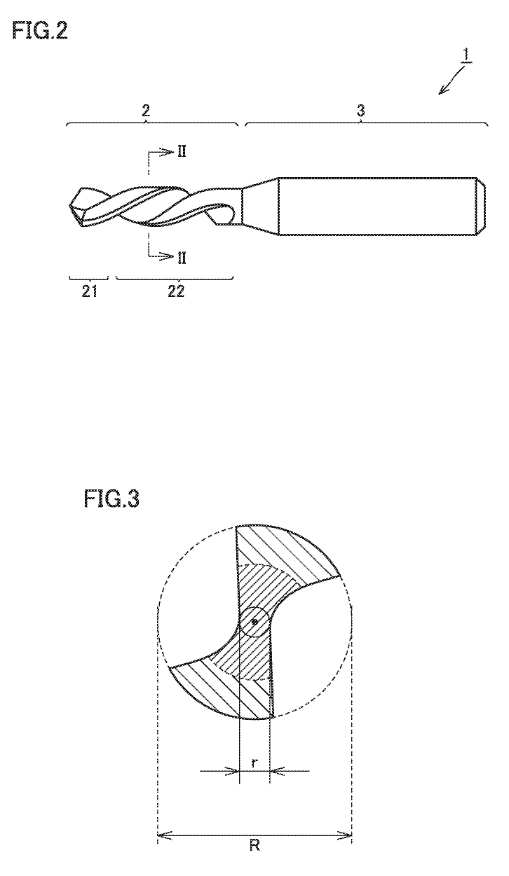

The first rod section occupies a predetermined region in the longitudinal direction of the rod. The first rod section occupies, when used for the drill bit body to be described later, a region to be a drill bit main body portion 22 of a drill 1 shown in FIG. 2. The second rod section occupies a region different from the first rod section in the longitudinal direction of the rod. The second rod section occupies, when used for the drill bit body to be described later, a region to be a drill bit tip end portion 21 (tip of the drill) of drill 1 shown in FIG. 2.

The first rod section has composition including A% by mass of cobalt, 0 to 1% by mass of chromium, 0 to 0.5% by mass of vanadium, and remainder of tungsten carbide and unavoidable impurities. The second rod section has composition including B% by mass of cobalt, 0 to 1% by mass of chromium, 0 to 0.5% by mass of vanadium, and remainder of tungsten carbide and unavoidable impurities. The first rod section and the second rod section each include greater than or equal to 0.1% by mass of at least one of chromium and vanadium. Further, it is preferable that, in each of the first rod section and the second rod section, a total amount of chromium and vanadium is 0.2 to 1.5% by mass. In the first rod section and the second rod section, the content of chromium is less than or equal to 1% by mass and the content of vanadium is less than or equal to 0.5% by mass.

Particularly, contents of cobalt in the first rod section and the second rod section satisfy a relationship of 1% by mass≤B<≤20% by mass. The relationship of 1% by mass≤B<≤20% by mass indicates that the content of cobalt in drill bit main body portion 22 of drill 1 shown in FIG. 2 is in the range of 1 to 20% by mass when used for the drill bit body described later, and the content of cobalt in drill bit main body portion 22 is larger than the content of cobalt in drill bit tip end portion 21. Cobalt is known to contribute to improvement of the toughness of the rod. Therefore, drill bit main body portion 22 of drill 1 having more cobalt content has improved toughness. Hence, it is possible to impart excellent breakage resistance based on this toughness to drill bit main body portion 22 of drill 1. Furthermore, in drill bit tip end portion 21, since the content of tungsten carbide as the remainder is increased while the content of cobalt is decreased, it is possible to impart abrasion resistance to drill bit tip end portion 21 of drill 1 based on physical property of hardness of tungsten carbide. The preferable composition of the first rod section includes 3 to 20% by mass of cobalt, 0.2 to 1% by mass of chromium, 0 to 0.5% by mass of vanadium, and remainder of tungsten carbide and unavoidable impurities. The preferable composition of the second rod section includes 1 to 15% by mass of cobalt, 0.2 to 1% by mass of chromium, 0 to 0.5% by mass of vanadium, and remainder of tungsten carbide and unavoidable impurities. Here, in the present embodiment, elements whose mixing cannot be avoided in manufacture of the rod are collectively called the unavoidable impurities. The content of each element as unavoidable impurity is 0 to 0.1% by mass, and the sum of each element (that is, the content of unavoidable impurities) is 0 to 0.2% by mass.

In the composition of the first rod section, when cobalt is less than 1% by mass, the breakage resistance becomes insufficient, and when cobalt exceeds 20% by mass, the rigidity becomes insufficient. When neither chromium nor vanadium is contained, tungsten carbide becomes coarse in a sintering process, and the breakage resistance may be insufficient. Therefore, the composition of the first rod section includes greater than or equal to 0.1% by mass of at least one of chromium and vanadium, preferably includes both, and most preferably includes 0.4 to 1.2% by mass of chromium and vanadium in total. However, when chromium exceeds 1% by mass or vanadium exceeds 0.5% by mass, the strength remarkably decreases.

In the composition of the second rod section, when cobalt is less than 1% by mass, wear caused by chipping progresses, and when cobalt exceeds 20% by mass, the abrasion resistance becomes insufficient. When neither chromium nor vanadium is included, tungsten carbide becomes coarse in the sintering process, and the abrasion resistance may be insufficient depending on the degree thereof. Therefore, the composition of the first rod section includes greater than or equal to 0.1% by mass of at least one of chromium and vanadium, preferably includes both, and most preferably includes 0.4 to 1.2% by mass of chromium and vanadium in total. However, when chromium exceeds 1% by mass or vanadium exceeds 0.5% by mass, the abrasion resistance decreases.

Furthermore, it is preferable that contents of cobalt in the first rod section and the second rod section satisfy a relationship of 3% by mass≤B<≤13% by mass. In particular, it is more preferable that the relationship of B/A 0.9 is satisfied. This is because the effect of imparting abrasion resistance to the tip end portion of the drill bit body and the effect of imparting breakage resistance to the main body portion of the drill bit body become more remarkable.

Here, the compositions of the first rod section and the second rod section of the rod can be measured by the following measurement method using a wavelength dispersive X-ray analyzer (WDS: Wavelength Dispersive X-ray Spectroscopy) provided with a field emission scanning electron microscope (FE-SEM: Field Emission Scanning Electron Microscopy).

First, the rod is filled with resin in the longitudinal direction thereof and polished so that the vicinity of the axial center of the rod is exposed, and thus a polished surface for observation of the first rod section and a polished surface for observation of the second rod section are produced. Further, an observation range to be described later is set for each of these polished surfaces for observation, composition analysis is performed at arbitrary five positions (5 fields of view) within the observation range with a magnification of 1,000 times by using WDS, and the values thereof are obtained. Finally, by obtaining the average value of the values of each of the five fields of view, the compositions of the first rod section and the second rod section can be specified.

The observation range is set as a rectangular region including the vicinity of the middle portion of the length in the longitudinal direction of the first rod section and the second rod section. Specifically, the polished surface for observation of the first rod section has a rectangular region set at a position at 30 to 70% of the entirety of the first rod section from one end of the first rod section in the longitudinal direction. The polished surface for observation of the second rod section has a rectangular region set at a position at 30 to 70% of the entirety of the second rod section from one end of the second rod section in the longitudinal direction. These rectangular regions may be set as the observation ranges for WDS.

For example, in the case of the first rod section having a length of 10 mm in the longitudinal direction and a length of 1 mm in a direction perpendicular to the longitudinal direction, 0.4 to 0.6 mm to the inside from one end in a direction perpendicular to the longitudinal direction is polished to expose its cross section. By setting a rectangular region at a position of 3 to 7 mm from one end in the longitudinal direction of this cross section, this rectangular region can be set as the observation range. Phenolic resin, epoxy resin, and the like can be used as the resin to fill the rod. Furthermore, a conventionally known method can be used for polishing the cross section of the first rod section and the cross section of the second rod section along the longitudinal direction.

In the rod according to the present embodiment, the second rod section has a length of 10 to 1000% with respect to the first rod section in the longitudinal direction. When used for the drill bit body as described above, the second rod section occupies the tip end of the drill (drill bit tip end portion 21 of drill 1 in FIG. 2). Therefore, by making the second rod section shorter than (less than 100% of) the first rod section in the longitudinal direction, the breakage resistance of the entirety of the drill bit body can be improved. Meanwhile, by making the second rod section longer than (more than 100% of) the first rod section in the longitudinal direction, the rigidity of the entirety of the drill bit body can be enhanced, and the hole position precision in the drilling processing can be improved. Further, by appropriately changing the size of the second rod section within the above-mentioned range, applicable types of processing target object and the like can be greatly expanded. The second rod section preferably has a length of 50 to 200% with respect to the first rod section in the longitudinal direction. This is because the above-mentioned effect is exhibited remarkably.

<Third Rod Section and Fourth Rod Section>

The rod according to the present embodiment preferably includes a third rod section and a fourth rod section. The third rod section includes cobalt, chromium, vanadium, tungsten carbide, and unavoidable impurities, and the average particle diameter of tungsten carbide therein is X μm. The fourth rod section includes cobalt, chromium, vanadium, tungsten carbide, and unavoidable impurities, and the average particle diameter of tungsten carbide therein is Y μm. The third rod section occupies a region partially or entirely overlapping the first rod section in the longitudinal direction, and the fourth rod section occupies a region partially or entirely overlapping the second rod section in the longitudinal direction. Particularly, when the rod is used for the drill bit body described later, the fourth rod section occupies a region that overlaps, at least on the tip end side of drill bit tip end portion 21, the second rod section occupying the region of drill bit tip end portion 21 of drill 1.

Furthermore, the composition of the third rod section is the same as the first rod section that the region thereof partially or entirely overlaps in the region partially or entirely overlapping the first rod section. The composition of the fourth rod section is the same as the second rod section that the region thereof partially or entirely overlaps in the region partially or entirely overlapping the second rod section.

In the third rod section and the fourth rod section, the average particle diameters of tungsten carbide satisfy a relationship of X≤Y. The relationship of X≤Y indicates that, when used for the drill bit body described later, an average particle diameter (X) of tungsten carbide in drill bit main body portion 22 of drill 1 shown in FIG. 2 is equal to or smaller than an average particle diameter (Y) of tungsten carbide in drill bit tip end portion 21 of drill 1. The present inventors have found that, by increasing the average particle diameter of tungsten carbide in drill bit tip end portion 21 of drill 1, an effect of preventing shedding caused by friction during processing is exhibited. By suppressing the shedding, the abrasion resistance of drill bit tip end portion 21 of drill 1 is enhanced. Therefore, excellent abrasion resistance can be imparted to drill bit tip end portion 21 of drill 1. Furthermore, by reducing the average particle diameter of tungsten carbide in drill bit main body portion 22 of drill 1, the breakage resistance is enhanced. Therefore, excellent breakage resistance can be imparted to drill bit main body portion 22 of drill 1. Specifically, the average particle diameter of tungsten carbide is preferably 0.1 to 2 μm. In this range, X is preferably 0.1 to 0.8 μm, and Y is preferably 0.2 to 2 μm.

In the third rod section and the fourth rod section, the average particle diameters of tungsten carbide more preferably satisfy a relationship of X<Y. Further, in the relationship of the average particle diameters of tungsten carbide in the third rod section and a fourth rod section, it is even more preferable that a relationship of Y/X≥1.4 is satisfied. This is because the effect of suppressing shedding and the effect on breakage resistance become remarkable. When the average particle diameter of tungsten carbide has the relationship of X>Y, it becomes difficult to obtain the effect of suppressing shedding, and the breakage resistance also decreases, so that it is not preferable.

The average particle diameters of tungsten carbide in the third rod section and the fourth rod section can be measured by the following measurement method with use of a field emission scanning electron microscope (FE-SEM) and commercially available image analysis software.

First, the polished surface for observation of the first rod section and the polished surface for observation of the second rod section are produced by the same method as the method for measuring the composition of the rod. Here, it is assumed that the polished surface for observation of the first rod section also serves as a polished surface for observation of the third rod section and the polished surface for observation of the second rod section also serves as a polished surface for observation of the fourth rod section. This is because, as described above, since the third rod section occupies a region that partially or entirely overlaps the first rod section, and the fourth rod section occupies a region that partially or entirely overlaps the second rod section, it becomes possible to obtain the average particle diameter of tungsten carbide by using the polished surfaces for observation described above.

Further, the same observation ranges as those used in the method of measuring the composition of the rod are respectively set in these polishing surfaces for observation, and by using FE-SEM with a magnification of 20000 times, image capturing is performed at arbitrary 5 positions (5 fields of view) in each of the observation ranges, and five microscopic images are obtained for each of the polished surface for observation of the first rod section and the polished surface for observation of the second rod section.

Subsequently, the microscopic images are analyzed by the image analysis software described above, and tungsten carbide particles appearing in these microscopic images are approximated by circles and diameters thereof are determined. Three thousand or fewer tungsten carbide particles appear in one field of view in the microscope image, and the diameters of all these particles are obtained. Finally, by calculating the average value of the diameters of the obtained particles, respectively, the average particle diameters of tungsten carbide in the third rod section and the fourth rod section can be specified.

In the rod according to the present embodiment, the fourth rod section has a length of 10 to 1000% with respect to the third rod section in the longitudinal direction. When the rod is used for the drill bit body as described above, the fourth rod section occupies the tip end of the drill (drill bit tip end portion 21 of drill 1 in FIG. 2). Therefore, by making the fourth rod section shorter than (less than 100% of) the third rod section in the longitudinal direction, the breakage resistance of the entirety of the drill bit body can be improved. Meanwhile, by making the fourth rod section longer than (more than 100% of) the third rod section in the longitudinal direction, the abrasion resistance of the tip end of the drill can be enhanced. Further, by appropriately changing the size of the fourth rod section within the above-mentioned range, applicable types of processing target object and the like can be greatly expanded. The fourth rod section preferably has a length of 50 to 200% with respect to the third rod section in the longitudinal direction. This is because the above-mentioned effect is exhibited remarkably.

<Fifth Rod Section>

The rod according to the present embodiment may include a fifth rod section occupying a predetermined region between the first rod section and the second rod section in the longitudinal direction. The fifth rod section occupies a region overlapping both or either one of the third rod section and the fourth rod section in the longitudinal direction. That is, as will be described in examples and the like to be described later, in the case of manufacturing a rod in which positions of a boundary surface that is a boundary perpendicular to the longitudinal direction of the rod where the content of cobalt changes and a boundary surface that is a boundary perpendicular to the longitudinal direction of the rod where the average particle diameter of tungsten carbide changes are different (do not coincide), the rod includes the fifth rod section.

The fifth rod section has composition including C% by mass of cobalt, 0 to 1% by mass of chromium, 0 to 0.5% by mass of vanadium, and remainder of tungsten carbide and unavoidable impurities. In the fifth rod section, in a relationship of A% by mass that is the content of cobalt in the first rod section, and B% by mass that is the content of cobalt in the second rod section, the content of cobalt satisfies a relationship of A≥C or C≥B. Further, the fifth rod section includes greater than or equal to 0.1% by mass of at least one of chromium and vanadium.

Specifically, C% by mass that is the content of cobalt in the fifth rod section is 1 to 20% by mass, and is preferably 2 to 18% in a range satisfying the relationship of A≥C or C≥B. The contents of chromium and vanadium are determined depending on the contents of chromium and vanadium in a first rod section and a second rod section, and the contents of chromium and vanadium are respectively in the range of 0 to 1% by mass and 0 to 0.5% by mass.

In the composition of the fifth rod section, when cobalt is less than 1% by mass, the breakage resistance becomes insufficient, and when cobalt exceeds 20% by mass, the rigidity becomes insufficient. When neither chromium nor vanadium is contained, tungsten carbide becomes coarse in a sintering process, and the breakage resistance may be insufficient. Therefore, the composition of the fifth rod section includes greater than or equal to 0.1% by mass of at least one of chromium and vanadium, preferably includes both, and most preferably includes 0.4 to 1.2% by mass of chromium and vanadium in total. However, when chromium exceeds 1% by mass or vanadium exceeds 0.5% by mass, the strength remarkably decreases.

The composition of the fifth rod section can be measured by a method similar to the method of measuring the composition of the first rod section and the second rod section. Specifically, polishing is performed so that the vicinity of the axial center of the rod is exposed, and a portion that is at 30 to 70% from one end in the longitudinal direction of the exposed cross section of the fifth rod section is set as a rectangular region. Using this as an observation range, composition analysis is performed at arbitrary five positions (5 fields of view) within the above-mentioned observation range with a magnification of 1000 by using WDS. This makes it possible to specify the composition of the fifth rod section.

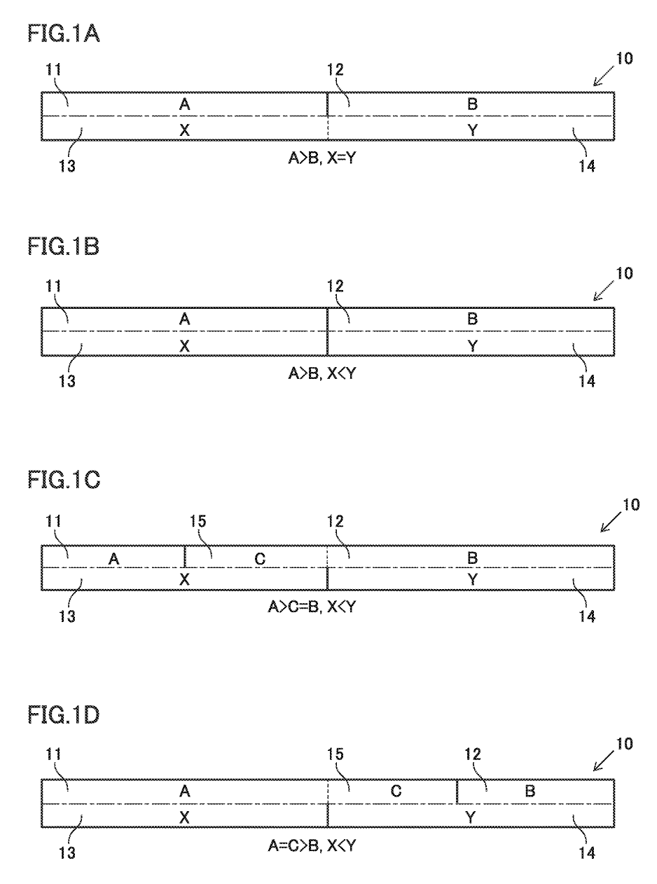

Here, examples of regions respectively occupied by the first to fifth rod sections in the longitudinal direction of the rod according to the present embodiment are schematically shown in FIGS. 1A to 1D. In these diagrams, boundary surfaces that are cross sections perpendicular to the longitudinal direction of the rod and serve as boundaries between rod sections are each indicated by a solid line, a broken line or a one-dot chain line. The solid line shows a boundary surface where the cobalt content and the average particle diameter of tungsten carbide change. The broken line indicates a boundary surface where the cobalt content or the average particle diameter of tungsten carbide is constant. The one-dot chain line indicates that each rod section occupies the region in an overlapping manner, by conceptually dividing the region vertically.

In a rod 10 shown in FIG. 1A, a third rod section 13 occupies a region entirely overlapping a first rod section 11. A fourth rod section 14 occupies a region entirely overlapping a second rod section 12. The cobalt contents satisfy the relationship of A>B, and the average particle diameters of tungsten carbide satisfy a relationship of X=Y. Therefore, the boundary surface that is a boundary where the cobalt content changes in rod 10 shown in FIG. 1A is present at the boundary between first rod section 11 and second rod section 12. There is no boundary surface that is a boundary where the average particle diameter of tungsten carbide changes.

In rod 10 shown in FIG. 1B, third rod section 13 occupies a region entirely overlapping first rod section 11. Fourth rod section 14 occupies a region entirely overlapping second rod section 12. The cobalt contents satisfy the relationship of A>B, and the average particle diameters of tungsten carbide satisfy the relationship of X<Y. Therefore, the boundary surface that is a boundary where the cobalt content changes in rod 10 shown in FIG. 1B is present at the boundary between first rod section 11 and second rod section 12. The boundary surface that is a boundary where the average particle diameter of tungsten carbide changes is present at the boundary between third rod section 13 and fourth rod section 14. The positions of these boundary surfaces coincide.

In rod 10 shown in FIG. 1C, third rod section 13 occupies a region partially overlapping first rod section 11. Fourth rod section 14 occupies a region entirely overlapping second rod section 12. A fifth rod section 15 occupies a region that is a region between first rod section 11 and second rod section 12 in the longitudinal direction and overlapping third rod section 13. The cobalt contents satisfy a relationship of A>C=B, and the average particle diameters of tungsten carbide satisfy the relationship of X<Y. Therefore, the boundary surface that is a boundary where the cobalt content changes in rod 10 shown in FIG. 1C is present at the boundary between first rod section 11 and fifth rod section 15. The boundary surface that is a boundary where the average particle diameter of tungsten carbide changes is present at the boundary between third rod section 13 and fourth rod section 14. That is, the positions of these boundaries are different.

In rod 10 shown in FIG. 1D, third rod section 13 occupies a region entirely overlapping first rod section 11. Fourth rod section 14 occupies a region partially overlapping second rod section 12. A fifth rod section 15 occupies that is a region between first rod section 11 and second rod section 12 and overlapping fourth rod section 14. The cobalt contents satisfy a relationship of A=C>B, and the average particle diameters of tungsten carbide satisfy the relationship of X<Y. Therefore, the boundary surface that is the boundary where the cobalt content changes in rod 10 shown in FIG. 1D is present at the boundary between the second rod section 12 and fifth rod section 15. The boundary surface that is a boundary where the average particle diameter of tungsten carbide changes is present at the boundary between third rod section 13 and fourth rod section 14. That is, the positions of these boundaries are different.

In the rod according to the present embodiment, even in the case where the position of the boundary surface that is a boundary where the content of cobalt changes and the position of the boundary surface that is a boundary where the average particle diameter of tungsten carbide changes coincide with each other, a fifth rod section can be included. Furthermore, the rod according to the present embodiment includes a fifth rod section, and, for example, a case where two boundary surfaces that are boundaries where the content of cobalt changes are formed and the content of cobalt satisfies a relationship of B<C<A is included.

(Unavoidable Impurities)

The rod according to the present embodiment may or may not include at least one unavoidable impurity selected from the group consisting of metals such as the group 4 elements (Ti, Zr, Hf, etc.), the group 5 elements (Nb, Ta, etc.), and the group 6 elements (Mo, W, etc.) in the periodic table, nickel (Ni), and iron (Fe), semimetals such as boron (B), and nonmetals such as carbon (C), nitrogen (N), oxygen (O), and chlorine (Cl) as long as the effect of simultaneously realizing both of the abrasion resistance and the breakage resistance is not affected. As described above, the content of each element as unavoidable impurity is 0 to 0.1% by mass, and the sum of each element (that is, the content of unavoidable impurities) is 0 to 0.2% by mass.

<<Drill Bit Body>>

The drill bit body according to the present embodiment is a drill bit body including the rod described above. Since the drill bit body includes the rod described above, the drill bit body includes tungsten carbide as the hard phase and cobalt as the binder phase. The drill bit body has a length of 0.5 to 15 mm, and the maximum diameter thereof in a cross section perpendicular to the longitudinal direction is 0.03 to 3.175 mm. Further, the tip end of the drill bit body is occupied by the second rod section. Since the fourth rod section is also as described above, the fourth rod section occupies at least the tip end side of the tip end of the drill bit body occupied by the second rod section. In the present embodiment, the region occupied by the second rod section in the drill bit body is referred to as the tip end portion of the drill bit body. The region occupied by the first rod section in the drill bit body is referred to as the main body portion of the drill bit body.

Therefore, in the tip end portion of the drill bit body, the cobalt content (B% by mass) is lower than the cobalt content (A% by mass) in the main body portion of the drill bit body. Furthermore, the average particle diameter (Y μm) of tungsten carbide in the tip end portion of the drill bit body tends to be larger than the average particle diameter (X μm) of tungsten carbide in the main body portion of the drill bit body. This makes it possible to impart abrasion resistance to the tip end portion of the drill bit body. The main body portion of the drill bit body can have breakage resistance because the cobalt content (A% by mass) is large and the average particle diameter (X μm) of tungsten carbide is small therein.

<Shape of Bit Body (Longitudinal Direction)>

As shown in FIG. 2, in the present embodiment, the bit body of drill 1 corresponds to a cutting edge portion 2 in a structure of a drill consisting of a shank 3 gripped by a mechanism for applying a rotational force to drill 1 and cutting edge portion 2 connected to shank 3. In the bit body (cutting edge portion 2) of drill 1, a groove is engraved spirally along the longitudinal direction, and a cutting edge is formed at the edge of the groove. The bit body of drill 1 includes drill bit tip end portion 21 that makes direct contact with the processing target object to perform drilling and drill bit main body portion 22 that discharges, through the groove described above, cutting chips or the like of the processing target object generated by drill bit tip end portion 21. In the present embodiment, drill 1 may have a structure in which shank 3 separated from drill 1 is integrated with cutting edge portion 2 (drill bit body) by welding or the like, and may have a single-body structure in which shank 3 and cutting edge portion 2 are cut out of a single rod.

The bit body of drill 1 according to the present embodiment has a length of 0.5 to 15 mm, and the maximum diameter thereof in a cross section perpendicular to the longitudinal direction is 0.03 to 3.175 mm. The length of the bit body of drill 1 is a length in the longitudinal direction including drill bit tip end portion 21 and drill bit main body portion 22, and is a range in which a spiral groove along the longitudinal direction is engraved. Therefore, the length of the bit body of drill 1 does not include the length of shank 3. The maximum diameter in the cross section perpendicular to the longitudinal direction of the bit body of drill 1 corresponds to a diameter at a portion in the cross section perpendicular to the longitudinal direction of drill bit tip end portion 21 and drill bit main body portion 22 where a circumscribed circle thereof is the largest. The length of the bit body of drill 1 and the maximum diameter thereof are appropriately determined in the above range in accordance with the application thereof.

A drill whose length of the drill bit body is less than 0.5 mm is not preferable because the application and purpose thereof are very limited. A drill whose length exceeds 15 mm is not preferable because the breakage resistance thereof is low. A drill whose maximum diameter of the drill bit body is less than 0.03 mm is difficult to be manufactured, and a drill whose maximum diameter exceeds 3.175 mm often has a diameter larger than that of the shank, and is not preferable because more steps tend to be required for manufacture thereof or quality thereof tends to be unstable.

As described above, in the bit body of drill 1, the second rod section occupies the region of drill bit tip end portion 21, and the fourth rod section overlapping this second rod section occupies at least a region on the tip end side of drill bit tip end portion 21. Further, the first rod section occupies the region of drill bit main body portion 22 of drill 1, and the third rod section occupying the region partially or entirely overlapping the first rod section occupies drill bit main body portion 22 in the overlapping range.

<Shape of Bit Body (Cross Section Perpendicular to the Longitudinal Direction)>

It is preferable that the bit body of drill 1 satisfies a relationship of 0.05R≤r≤0.6R when R represents the maximum diameter and r represents a web thickness in the cross section. The web thickness corresponds to a central portion that remains after a groove is spirally engraved in a cross section perpendicular to the longitudinal direction of the bit body of drill 1. Therefore, the web thickness is represented by a virtual circle formed by connecting the deepest parts of the groove with a virtual line, that is, a virtual circle indicated by a solid line in FIG. 3, and the diameter of this virtual circle is expressed as a thickness r of the web thickness.

As a result of satisfying the relationship of 0.05R≤r≤0.6R, the drill bit body can be said to have a deeper groove depth than a conventional drill bit body. As a result, the drill bit body has good dischargeability of the cutting chips in drill bit main body portion 22. In the present embodiment, since sufficient breakage resistance is imparted to drill bit main body portion 22 of drill 1 by using the rod described above, a deeper groove can be defined, and the above relationship can be satisfied. From the viewpoint of dischargeability and strength, it is more preferable that the relationship between the maximum diameter R and the thickness r of the web thickness satisfies the relationship of 0.1R≤r≤0.5R.

Here, the thickness r of the web thickness can be calculated by performing observation and measurement by an SEM. Specifically, an observation surface serving as the field of view of the SEM and the cross section perpendicular to the longitudinal direction of the drill are made parallel, the focal point of the SEM is adjusted to the tip end of the drill bit body, the deepest parts of the groove of the bit body are connected by a virtual line to form a virtual circle, and the thickness r of the web thickness is calculated by measuring the diameter of the virtual circle. The thickness r of the web thickness is preferably expressed as an average value of values calculated from five or more drills that are prepared. The maximum diameter R may be measured by a conventionally known method.

<Effect>

As described above, the drill bit body according to the present embodiment can meet the requirement for high-speed processing, for example, in drilling a printed board of a semiconductor device. Specifically, the above requirement can be met as a result of the tip end portion of the drill bit body having abrasion resistance and the main body portion of the drill bit body having breakage resistance. Therefore, the drill bit body according to the present embodiment can realize both abrasion resistance and breakage resistance.

<<Rod Manufacturing Method>>

A rod manufacturing method according to the present embodiment is a method for manufacturing the rod described above, and includes a first step of preparing first powder having composition including A% by mass of cobalt, 0 to 1% by mass of chromium, 0 to 0.5% by mass of vanadium, and remainder of tungsten carbide and unavoidable impurities and second powder having composition including B% by mass of cobalt, 0 to 1% by mass of chromium, 0 to 0.5% by mass of vanadium, and remainder of tungsten carbide and unavoidable impurities. Further, the rod manufacturing method includes a second step of charging the first powder into a mold and pressing the first powder with a first pressure, and a third step of charging the second powder into the mold and pressing the second powder with a second pressure equal to or lower than the first pressure.

<First Step>

In the first step, the first powder having the composition including A% by mass of cobalt, 0 to 1% by mass of chromium, 0 to 0.5% by mass of vanadium, and remainder of tungsten carbide and unavoidable impurities and the second powder having the composition including B% by mass of cobalt, 0 to 1% by mass of chromium, 0 to 0.5% by mass of vanadium, and remainder of tungsten carbide and unavoidable impurities are prepared.

The first powder serves as a raw material for the first rod section of the rod and the second powder serves as a raw material for the second rod section of the rod. Therefore, the first powder also serves as a raw material for a part or the whole of the third rod section, and the second powder also serves as a raw material for a part or the whole of the fourth rod section. Furthermore, in the first powder and the second powder, contents of cobalt satisfy a relationship of 1% by mass≤B<≤20% by mass. The first powder and the second powder each include greater than or equal to 0.1% by mass of at least one of chromium and vanadium, and preferably each include 0.2 to 1.5% by mass of chromium and vanadium in total. In the first powder and the second powder, the content of chromium is less than or equal to 1% by mass and the content of vanadium is less than or equal to 0.5% by mass. Hereinafter, the first step of preparing the first powder and the second powder will be specifically described.

(Raw Material Powder Blending Step)

In the raw material powder blending step, elements and compounds contained in the first rod section and the second rod section are blended by using a conventionally known method. In other words, each element and compound are blended by a conventionally known blending method, in a predetermined proportion so as to satisfy the above-described composition of the first powder and satisfy the above-described composition of the second powder. At this time, the cobalt content is set to such an amount as to satisfy a relationship of 1% by mass≤B<≤20% by mass as described above.

(Wet Mixing Step)

Subsequently, in a wet mixing step, a blend for the first powder and a blend for the second powder in which each element and compound are blended in a predetermined ratio are each subjected to wet-mixing. Conventionally known methods can also be used for wet mixing. Specifically, the first powder and the second powder can be prepared by mixing the blend for the first powder and the blend for the second powder for 5 to 20 hours or more by a conventionally known method. For example, by wet-mixing the blend for the first powder and the blend for the second powder for about 15 hours by using a commercially available wet attritor apparatus, the first powder and the second powder in which the concentration of each element and compound is not locally unbalanced can be prepared.

<Second Step>

In the second step, the first powder is charged into a mold and pressed with a first pressure. First, a mold for obtaining a rod (for example, a round rod) having a diameter of 0.03 to 3.175 mm is prepared, the first powder is charged into this mold, and press molding is performed at a pressure of 49 to 200 MPa. At that time, since a molded body of the first powder shrinks by sintering to form the first rod section in a sintering step to be described later, it is preferable to prepare a mold having a diameter determined in consideration of the degree of this shrinkage.

<Third Step>

In the third step, the second powder is charged into the mold described above and pressed at a second pressure equal to or lower than the first pressure. Specifically, the second powder is charged into the mold in which the first powder remains at the bottom as a molded body, and press molding is performed at a pressure of 49 to 200 MPa that is equal to or lower than the first pressure.

As described above, a case where the second pressure for pressing the second powder is lower than the first pressure for pressing the first powder is included. The reason for this is based on the fact that it is necessary to manufacture a smooth rod that is dense inside and is not uneven on the surface by setting the shrinkage rates of the molded body of the first powder and the molded body of the second powder to about the same degree. In the case where the average particle diameter of tungsten carbide contained in the first powder is different from that of tungsten carbide contained in the second powder, if the first pressure and the second pressure are set to the same pressure value, in the sintering step to be described later, the shrinkage rate of the molded body to be shrunk by the sintering differs between the molded body of the first powder and the molded body of the second powder. This is because it is difficult to manufacture a smooth rod that is dense inside and is not uneven on the surface.

That is, as described above, the average particle diameter of tungsten carbide satisfies the relationship of X≥Y. Therefore, since the average particle diameter of tungsten carbide in the first powder is X μm, the first powder contains so-called fine particles of tungsten carbide, and since the average particle diameter of tungsten carbide in the second powder is Y μm, the second powder contains so-called coarse particles of tungsten carbide. Since the tungsten carbide in the first powder is in the form of fine particles, a large number of voids are generated between the particles, and thus the volume per unit mass thereof is larger than that of the second powder in which tungsten carbide is in the form of coarse particles (that is, the first powder is bulkier than the second powder). Therefore, when the first pressure and the second pressure are set to the same pressure value, the first powder becomes a molded body in a state of being bulkier than the second powder (that is, the first powder becomes a molded body lacking denseness). Meanwhile, since the rod manufactured through the sintering step has a predetermined size (that is, the shrinkage rate differs between the molded body of the first powder and the molded body of the second powder), a rod that is smooth, dense inside, and not uneven on the surface in the first rod section may be not manufactured.

(Sintering Step)

In the sintering step, the molded body in a state in which the molded body of the first powder and the molded body of the second powder obtained in the second step and the third step are integrated is sintered. This sintering can be carried out by using a conventionally known method. That is, by sintering the molded body described above at 1350 to 1450° C. by the conventionally known method, a sintered body including the first powder and the second powder can be prepared. For example, by sintering the above-mentioned molded body under conditions of about 1380° C. and about 1 hour with use of a commercially available sintering apparatus, a smooth sintered body that is dense inside and is not uneven on the surface thereof can be prepared.

<Other Steps>

In the rod manufacturing method according to the present embodiment, it is preferable to finish the sintered body by a hot isostatic pressing method (HIP method). Specifically, by performing the hot isostatic pressing method under conditions of about 1350° C. and 1 hour, the rod according to the present embodiment can be manufactured. As a result, a smooth rod that is dense inside and is not uneven on the surface can be securely obtained.

Furthermore, the rod manufacturing method according to the present embodiment may further include a fourth step of preparing third powder having composition including C% by mass of cobalt, 0 to 1% by mass of chromium, 0 to 0.5% by mass of vanadium, and remainder of tungsten carbide and unavoidable impurities, and a fifth step of charging the third powder into the mold and pressing the third powder with a third pressure equal to or lower than the first pressure and equal to or higher than the second pressure. Since the third powder serves as a raw material for the fifth rod section of the rod described above, in the relationship between the first powder and the second powder, the cobalt content satisfies a relationship of A≥C or C≥B. Further, the third powder includes greater than or equal to 0.1% by mass of at least one of chromium and vanadium. In the third powder, the content of chromium is less than or equal to 1% by mass, and the content of vanadium is less than or equal to 0.5% by mass.

(Fourth Step)

In the fourth step, the third powder satisfying the above composition can be prepared by using a method similar to the step of preparing the first powder and the second powder in the first step. In other words, the third powder satisfying the above composition can be prepared through the raw material powder blending step and the wet mixing step.

(Fifth Step)

Furthermore, the fifth step can be performed at timing after the second step and before the third step. First, the third powder is charged into the mold in which the first powder remains at the bottom as a molded body after the second step, and press molding is performed at a pressure (third pressure) that is 49 to 200 MPa and equal to or lower than the first pressure. Thereafter, as the third step, the second powder may be charged into the mold in which the molded body of the first powder and a molded body of the third powder remain at the bottom, and press molding may be performed at the second pressure that is equal to or lower than the first pressure and equal to or lower than the third pressure. The reason why the press molding is performed in the order of the second step, the fifth step, and the third step is that the third powder is the raw material of the fifth rod section as described above, and this fifth rod section occupies a predetermined region between the first rod section and the second rod section in the rod. Furthermore, the reason for controlling the pressure at the time of press molding as described above is to make the shrinkage rates of the various molded bodies in the sintering step almost the same degree.

In the fifth step, the third pressure for pressing the third powder may be set higher than the second pressure when the third pressure is equal to the first pressure. Further, the third pressure for pressing the third powder may be set lower than the first pressure when the third pressure is equal to the second pressure. Thus, while setting the shrinkage rates of the various molded bodies in the sintering step to almost the same degree, a rod can be manufactured in which the boundary surfaces that are boundaries where the content of cobalt and the average particle diameter of tungsten carbide change are respectively formed at desired positions.

As described above, according to the rod manufacturing method of the present embodiment, in the case where a rod is used for a drill bit body in which the second rod section is a tip end portion of the drill bit body that makes direct contact with a processing target object and performs drilling or the like and the first rod section is a main body portion of the drill bit body that takes charge of discharging cutting chips or the like of the processing target object that has been generated at the tip end portion of the drill bit body, a rod can be manufactured in which abrasion resistance is imparted to the tip end portion of the drill bit body and breakage resistance is imparted to the main body portion of the drill bit body.

<<Drill Manufacturing Method>>

A drill manufacturing method according to the present embodiment is a method for manufacturing a drill by using the rod described above. The drill manufacturing method includes an α step of determining a central axis by cutting the rod, and a β step of defining a groove on the rod with reference to the central axis.

<α Step>

In the α step, a central axis is determined by cutting the rod described above. Here, the central axis is an axis passing through the center of a cross section perpendicular to the longitudinal direction of the drill along the longitudinal direction of the drill. By defining the central axis, the bit body does not shake when the drill rotates, so that the positional precision of the hole to be processed can be improved. As a method of determining the central axis of the drill with respect to the rod, a conventionally known method can be used.

<β Step>

In the β step, a groove is defined on the rod with reference to the central axis determined in the a process. Also for the method of defining the groove on the rod, a conventionally known method can be used. At this time, it is preferable that the relationship of 0.05R≤r≤0.6R is satisfied when R represents the maximum diameter of the drill bit body and r represents a web thickness. Further, the evaluation for whether or not a desired groove is defined can also be carried out by a conventionally known method.

<γ Step>

Further, the drill manufacturing method according to the present embodiment preferably includes a γ step of attaching a shank to the rod before the α step. By performing the γ step, the α step and β step performed after the γ step can be efficiently progressed in the case where the drill has a structure in which a shank separated from the drill is attached to the cutting edge portion (drill bit body) to form a single body. This is because the shank can be gripped by a mechanism that provides rotational force in the α step and the β step.

In the γ step, a shank is attached to the rod before the α step. The reason why the γ step is performed before the α step is that the central axis of the rod determined in the α step is affected by the attachment of the shank. As a method of attaching the shank to the rod, in addition to the above-mentioned welding method, a conventionally known method can be used. The evaluation for whether or not the shank has been securely attached to the rod can also be carried out by a conventionally known method.

As described above, in the drill manufacturing method according to the present embodiment, since the manufacture is carried out by using the rod described above, a drill can be manufactured in which abrasion resistance is imparted to the tip end portion of the drill bit body and breakage resistance is imparted to the main body portion of the drill bit body.

### EXAMPLES

In the following, the present invention will be described specifically by way of examples; however, it is to be noted that the present invention will not be limited to these.

In the present examples, the compositions of the first to fifth rod sections were measured by the measurement method described above with use of a WDS (trade name: “Inca Wave”, manufactured by Oxford Instruments) provided with an FE-SEM. Further, the average particle diameter of tungsten carbide was obtained by the measurement method described above by using an FE-SEM and commercially available image analysis software (trade name: “Mac-View”, manufactured by Mountech Co., Ltd.).

Further, in the present examples, 14 types of drills named Sample Nos. 1 to 14 as shown in Table 1 were manufactured, and the abrasion resistance and breakage resistance of the bit body thereof were evaluated. Since the drills of Sample Nos. 1 to 14 were evaluated based on average values in the measurement and evaluation test of the thickness r of the web thickness and the like, a plurality of drills necessary therefor were prepared for each sample. This will be described in detail below.

<<Manufacture of Rod>>

<Sample No. 1>

(First Step)

In the first step, first powder and second powder having compositions and average particle diameters of tungsten carbide as shown in Table 1 were prepared for manufacturing a round rod serving as a rod used for a drill of Sample No. 1 (hereinafter, a “round rod serving as the rod used for a drill of Sample No. X” will be sometimes referred to as a “round rod of Sample No. X”)). Particularly, at least required amounts of the first powder and the second powder that satisfy drill shapes (length, maximum diameter R, and length of the second rod section with respect to the length of the first rod section in the longitudinal direction [length of second rod section/length of first rod section (%)])) shown in Table 1 were prepared. In Table 1, since the first powder is the raw material of the first rod section of the rod and the composition of the first powder and that of the first rod section are the same, the composition of the first powder is expressed as the composition of the first rod section. Likewise, since the second powder is the raw material of the second rod section of the rod and the composition of the second powder and that of the second rod section are the same, the composition of the second powder is expressed as the composition of the second rod section.

In the preparation of the first powder and the second powder, first by a conventionally known blending method, each element and compound were blended in a predetermined proportion so as to satisfy the composition of the first powder shown in Table 1 and satisfy the composition of the second powder shown in Table 1 (raw material blending step). Subsequently, by wet-mixing the blend for the first powder and the blend for the second powder for 15 hours with use of a wet attritor apparatus (wet mixing step), the first powder and the second powder were prepared in which the concentration of each element and compound is not locally unbalanced.

(Second Step)

In the second step, a mold for obtaining a round rod having a diameter of 1.25 mm before shrinking by sintering was prepared, a required amount of the first powder was charged into the mold, and press molding was performed at a pressure of 98 MPa (first pressure).

(Third Step)

In the third step, a required amount of the second powder was charged into the mold described above in which the first powder remained at the bottom as a molded body, and press molding was performed at a pressure of 98 MPa (second pressure) that was equal to the first pressure.

(Sintering Step)

In the sintering step, the molded body in a state in which the molded body of the first powder and the molded body of the second powder obtained in the second step and the third step were integrated was sintered under conditions of 1380° C. and 1 hour by using a sintering apparatus, and thus a sintered body was obtained.

(Other Steps: Finishing Step Using HIP Method)

The sintered body was subjected to the HIP method under conditions of 1350° C. and 1 hour to produce a round rod of Sample No. 1.

<Sample Nos. 2, 3, 10, 13, and 14>

Round rods of Sample Nos. 2, 3, 10, 13, and 14 were manufactured by the same method as the manufacture of the round rod of Sample No. 1 except that the compositions of the first powder and the second powder were changed as shown in Table 1.

<Sample Nos. 4, 5, 6, 8, 9, 11, and 12>

Round rods of Sample Nos. 4, 5, 6, 8, 9, 11, and 12 were manufactured by the same method as the manufacture of the round rod of Sample No. 1 except that the compositions of the first powder and the second powder were changed as shown in Table 1 and the third step described below was performed.

Specifically, in the third step in the manufacture of the round rods of Sample Nos. 4, 5, 6, 8, 9, 11, and 12, a required amount of the second powder was charged into the mold in which the first powder remained at the bottom as a molded body, and press molding was performed at a pressure of 69 MPa (second pressure) that was lower than the first pressure.

<Sample No. 7>

A round rod of Sample No. 7 was manufactured by the same method as the manufacture of the round rod of Sample No. 1 except that the compositions of the first powder and the second powder were changed as shown in Table 1, the third powder was prepared in accordance with the composition shown in Table 1, and the fifth step and the third step were performed subsequently to the second step as described below. In Table 1, since the third powder is the raw material of the fifth rod section of the rod and the composition of the third powder and that of the fifth rod section are the same, the composition of the third powder is expressed as the composition of the fifth rod section.

That is, in the manufacture of the round rod of Sample No. 7, the third powder was first prepared (fourth step). As a preparation method thereof, the same method as the manufacture of the round rod of Sample No. 1 was used. Furthermore, the fifth step was performed subsequently to the second step, and then the third step was performed. In the fifth step, a required amount of the third powder was charged into the mold in which the first powder remained at the bottom as a molded body, and press molding was performed at a pressure of 69 MPa (third pressure) that was lower than the first pressure. In the third step after this, the second powder was charged into the mold in which the molded body of the first powder and the molded body of the third powder remained at the bottom, and press molding was performed at a pressure of 69 MPa (second pressure) that was equal to the third pressure.

<<Manufacture of Drill>>

<Sample Nos. 1 to 14>

(γ step)

In the γ step, for each of the round rods of Sample Nos. 1 to 14, a shank having a diameter of 3.175 mm was attached by welding to the end portion of the round rod on the side that the first rod section occupies in the longitudinal direction (on the drill bit main body portion side).

(α step)

In the α step, the round rods of sample Nos. 1 to 14 were cut to define the central axis. Specifically, the mechanism of providing rotational force was caused to grip the shanks attached to the round rods of Sample Nos. 1 to 14, and the surface of the rod was peeled while rotating the rod by the mechanism, whereby the central axis of the drill was defined.

<β Step>

In the β step, a groove was defined on the rod with reference to the central axis determined in the a process. Specifically, the mechanism of providing rotational force was caused to grip the shanks attached to the round rods of Sample Nos. 1 to 14, and the rotating rods were cut by a cutting tool brought into contact therewith at respective predetermined angles with respect to the longitudinal direction of the central axis and a direction perpendicular to this longitudinal direction, whereby the groove was defined. Further, the surface of the drill was finished by a conventionally known method so that the maximum diameter R of the drill was 0.3 mm and the thickness r of the web thickness was 0.08 mm. The method for calculating the maximum diameter R and the thickness r of the web thickness was as described above.

In the above manner, drills of Sample Nos. 1 to 14 were manufactured. Drill shapes of Sample Nos. 1 to 14 (length, maximum diameter R, thickness r of web thickness, and length of the second rod section with respect to the length of the first rod section in the longitudinal direction [length of second rod section/length of first rod section (%)]) are as shown in Table 1. Table 1 shows the length of the fourth rod section with respect to the length of the third rod section [length of the fourth rod section/length of the third rod section (%)] in the longitudinal direction of the round rod of Sample No. 7.

<<Evaluation Test>>

In the evaluation test, the abrasion resistance and breakage resistance of the drills of Sample Nos. 1 to 14 were evaluated.

A printed board having a thickness of 1.6 mm and formed by impregnating a glass cloth (composition: 54% by mass of SiO₂, 15% by mass of Al₂O₃, 17% by mass of CaO, 5% by mass of MgO, 8% by mass of B₂O₃, 0.6% by mass of alkali metal oxide (R₂O), and 0.4% by mass of impurities) serving as a base material with an epoxy resin layer and laminating and adhering a copper foil thereon was prepared. High-speed drilling was carried out with the drills of Sample Nos. 1 to 14 on two of this printed board superimposed on each other. The number of revolutions of the drills of Sample Nos. 1 to 14 during the high-speed drilling was 120000 rpm and the feed rate was 5 μm/rev. or the evaluation of the breakage resistance, the number of drilled holes (“number of drilled holes at breakage” [holes]) until the drill of each sample reached breakage was measured in the above test. Further, for the evaluation of the abrasion resistance, the amount of wear [decrease rate (%) of the diameter of the tip end portion of the drill between before and after the drilling] of the drill bit body when the number of drilled holes reached 3000 in the test described above was measured as a “wear ratio (%)”. These evaluations were calculated as the average value of five drills for each of Sample Nos. 1 to 14. The results thereof are shown in Table 1.

TABLE 1

| | | Composition ratio (% by mass) | | | | | |
|---|---|---|---|---|---|---|---|
| | | Tungsten | | | | | |
| | | carbide and | | | | Average particle | Drill shape |
| | | unavoidable | | | | diameter [μm] of | Length |
| Sample No. | | impurities | Cobalt | Chromium | Vanadium | tungsten carbide | [mm] |
| 1 | First rod section | Remainder | 15.0 | 0.95 | 0.48 | 0.30 | 4.0 |
| | Second rod section | Remainder | 11.0 | 0.90 | 0.40 | 0.30 | 1.5 |
| | Third rod section | Same as first rod section | | | | | |
| | Fourth rod section | Same as second rod section | | | | | |
| 2 | First rod section | Remainder | 10.0 | 0.85 | 0.30 | 0.30 | 4.0 |
| | Second rod section | Remainder | 6.0 | 0.75 | 0.20 | 0.30 | 1.5 |
| | Third rod section | Same as first rod section | | | | | |
| | Fourth rod section | Same as second rod section | | | | | |
| 3 | First rod section | Remainder | 6.0 | 0.75 | 0.20 | 0.30 | 4.0 |
| | Second rod section | Remainder | 2.0 | 0.70 | 0.05 | 0.30 | 1.5 |
| | Third rod section | Same as first rod section | | | | | |
| | Fourth rod section | Same as second rod section | | | | | |
| 4 | First rod section | Remainder | 15.0 | 0.95 | 0.48 | 0.30 | 4.0 |
| | Second rod section | Remainder | 11.0 | 0.90 | 0.40 | 0.80 | 1.5 |
| | Third rod section | Same as first rod section | | | | | |
| | Fourth rod section | Same as second rod section | | | | | |
| 5 | First rod section | Remainder | 10.0 | 0.85 | 0.30 | 0.30 | 4.0 |
| | Second rod section | Remainder | 6.0 | 0.75 | 0.20 | 0.80 | 1.5 |
| | Third rod section | Same as first rod section | | | | | |
| | Fourth rod section | Same as second rod section | | | | | |
| 6 | First rod section | Remainder | 6.0 | 0.75 | 0.20 | 0.30 | 4.0 |
| | Second rod section | Remainder | 2.0 | 0.70 | 0.05 | 0.80 | 1.5 |
| | Third rod section | Same as first rod section | | | | | |
| | Fourth rod section | Same as second rod section | | | | | |
| 7 | First rod section | Remainder | 10.0 | 0.85 | 0.30 | 0.30 | 3.5 |
| | Second rod section | Remainder | 6.0 | 0.75 | 0.20 | 0.80 | 1.5 |
| | Third rod section | Same as first rod section | | | | | 3.5 |
| | Fourth rod section | Same as second rod section | | | | | 2.0 |
| | Fifth rod section | Remainder | 10.0 | 0.85 | 0.30 | 0.80 | 0.5 |
| 8 | First rod section | Remainder | 10.0 | 0.85 | 0.30 | 0.30 | 5.0 |
| | Second rod section | Remainder | 6.0 | 0.75 | 0.20 | 0.80 | 0.5 |
| | Third rod section | Same as first rod section | | | | | |
| | Fourth rod section | Same as second rod section | | | | | |
| 9 | First rod section | Remainder | 10.0 | 0.85 | 0.30 | 0.30 | 0.6 |
| | Second rod section | Remainder | 6.0 | 0.75 | 0.20 | 0.80 | 4.9 |
| | Third rod section | Same as first rod section | | | | | |
| | Fourth rod section | Same as second rod section | | | | | |
| 10 | First rod section | Remainder | 10.0 | 0.85 | 0.30 | 0.30 | 4.0 |
| | Second rod section | Remainder | 10.0 | 0.85 | 0.30 | 0.30 | 1.5 |
| | Third rod section | Same as first rod section | | | | | |
| | Fourth rod section | Same as second rod section | | | | | |
| 11 | First rod section | Remainder | 10.0 | 0.85 | 0.30 | 0.30 | 5.2 |
| | Second rod section | Remainder | 6.0 | 0.75 | 0.20 | 0.80 | 0.3 |
| | Third rod section | Same as first rod section | | | | | |
| | Fourth rod section | Same as second rod section | | | | | |
| 12 | First rod section | Remainder | 10.0 | 0.85 | 0.30 | 0.30 | 0.4 |
| | Second rod section | Remainder | 6.0 | 0.75 | 0.20 | 0.80 | 5.1 |
| | Third rod section | Same as first rod section | | | | | |
| | Fourth rod section | Same as second rod section | | | | | |
| 13 | First rod section | Remainder | 23.0 | 0.98 | 0.49 | 0.30 | 4.0 |
| | Second rod section | Remainder | 19.0 | 0.97 | 0.48 | 0.30 | 1.5 |
| | Third rod section | Same as first rod section | | | | | |
| | Fourth rod section | Same as second rod section | | | | | |
| 14 | First rod section | Remainder | 4.0 | 0.70 | 0.10 | 0.30 | 4.0 |
| | Second rod section | Remainder | 0.5 | 0.50 | 0.03 | 0.30 | 1.5 |

| | Third rod section | Same as first rod section | | | | |
|---|---|---|---|---|---|---|
| | Fourth rod section | Same as second rod section | | | | |
| | | Drill shape | | | | |
| | | Length of second rod section/ | | | Evaluation | |
| | | length of first rod section | | Thickness | Number of | |
| | | (Length of fourth rod section/ | Maximum | of web | drilled holes | Wear |
| | | length of the third rod section) | diameter R | thickness r | at breakage | ratio |
| | Sample No. | [%] | [mm] | [mm] | [holes] | [%] |
| 1 | First rod section | — | 0.30 | — | 11200 | 6 |
| | Second rod section | 38% | 0.30 | 0.08 | | |
| | Third rod section | Same as first rod section | | | | |
| | Fourth rod section | Same as second rod section | | | | |
| 2 | First rod section | — | 0.30 | — | 12430 | 4 |
| | Second rod section | 38% | 0.30 | 0.08 | | |
| | Third rod section | Same as first rod section | | | | |
| | Fourth rod section | Same as second rod section | | | | |
| 3 | First rod section | — | 0.30 | — | 9250 | 5 |
| | Second rod section | 38% | 0.30 | 0.08 | | |
| | Third rod section | Same as first rod section | | | | |
| | Fourth rod section | Same as second rod section | | | | |
| 4 | First rod section | — | 0.30 | — | 12010 | 4 |
| | Second rod section | 38% | 0.30 | 0.08 | | |
| | Third rod section | Same as first rod section | | | | |
| | Fourth rod section | Same as second rod section | | | | |
| 5 | First rod section | — | 0.30 | — | 12650 | 1 |
| | Second rod section | 38% | 0.30 | 0.08 | | |
| | Third rod section | Same as first rod section | | | | |
| | Fourth rod section | Same as second rod section | | | | |
| 6 | First rod section | — | 0.30 | — | 9390 | 2 |
| | Second rod section | 38% | 0.30 | 0.08 | | |
| | Third rod section | Same as first rod section | | | | |
| | Fourth rod section | Same as second rod section | | | | |
| 7 | First rod section | — | 0.30 | — | 11520 | 1 |
| | Second rod section | 43% | 0.30 | 0.08 | | |
| | Third rod section | — | 0.30 | — | | |
| | Fourth rod section | 57% | 0.30 | 0.08 | | |
| | Fifth rod section | — | 0.30 | — | | |
| 8 | First rod section | — | 0.30 | — | 10920 | 5 |
| | Second rod section | 10% | 0.30 | 0.08 | | |
| | Third rod section | Same as first rod section | | | | |
| | Fourth rod section | Same as second rod section | | | | |
| 9 | First rod section | — | 0.30 | — | 7200 | 1 |
| | Second rod section | 817% | 0.30 | 0.08 | | |
| | Third rod section | Same as first rod section | | | | |
| | Fourth rod section | Same as second rod section | | | | |
| 10 | First rod section | — | 0.30 | — | 10810 | 7 |
| | Second rod section | 38% | 0.30 | 0.08 | | |
| | Third rod section | Same as first rod section | | | | |
| | Fourth rod section | Same as second rod section | | | | |
| 11 | First rod section | — | 0.30 | — | 4100 | 6 |
| | Second rod section | 6% | 0.30 | 0.08 | | |
| | Third rod section | Same as first rod section | | | | |
| | Fourth rod section | Same as second rod section | | | | |
| 12 | First rod section | — | 0.30 | — | 4300 | 1 |
| | Second rod section | 1275% | 0.30 | 0.08 | | |
| | Third rod section | Same as first rod section | | | | |
| | Fourth rod section | Same as second rod section | | | | |
| 13 | First rod section | — | 0.30 | — | 5240 | 10 |
| | Second rod section | 38% | 0.30 | 0.08 | | |
| | Third rod section | Same as first rod section | | | | |
| | Fourth rod section | Same as second rod section | | | | |
| 14 | First rod section | — | 0.30 | — | 5590 | 9 |
| | Second rod section | 38% | 0.30 | 0.08 | | |

| | |
|---|---|
| Third rod section | Same as first rod section |
| Fourth rod section | Same as second rod section |

<Discussion>

Drills of Sample Nos. 1 to 9 in which the first rod section and the second rod section had the predetermined compositions and satisfied the predetermined relationship of the content of cobalt and the second rod section had the predetermined length with respect to the first rod section in the longitudinal direction showed a good number of drilled holes (greater than or equal to 7200 holes) and a good wear amount of the drill bit body (less than or equal to 6%) and realized achievement of both of abrasion resistance and breakage resistance.

Particularly, it was found from the evaluation of Sample Nos. 1 to 3 that a good result can be obtained when the cobalt content is around 10% by mass within the range of 1 to 20% by mass. From the evaluation of Sample Nos. 1 to 3 and Samples Nos. 4 to 6, it was found that the amount of wear can be reduced by making the average particle diameter of tungsten carbide contained in the second rod section (drill bit tip end portion) coarse (0.8 μm).

From the evaluation of Sample No. 7, it was found that achievement of both the abrasion resistance and the breakage resistance can be realized even in the case of a drill in which positions of the boundary surface that is the boundary where the content of cobalt changes and the boundary surface that is the boundary where the average particle diameter of tungsten carbide changes are different. From the evaluation of Sample No. 8 and Sample No. 9, it was found that there is an appropriate value (at least greater than or equal to 10% and less than 817%) the ratio of the lengths of the first rod section and the second rod section.

In contrast, for the drills of Sample Nos. 10 to 14, good results could not be obtained at least for either one of the number of drilled holes and the amount of wear of the drill bit body, and thus the achievement of both the abrasion resistance and the breakage resistance was not realized.

Sample No. 10 could not obtain an evaluation good enough in the abrasion resistance because the contents of cobalt and the average particle diameters of tungsten carbide in the first rod section and the second rod section were the same. Sample Nos. 11 and 12 could not obtain evaluations good enough in both the abrasion resistance and the breakage resistance because ratios of lengths of the first rod section and the second rod section were not appropriate. Sample Nos. 13 and 14 could not obtain evaluations good enough in both the abrasion resistance and the breakage resistance because the contents of cobalt in the first rod section and the second rod section were not appropriate.

Although embodiments and examples of the present invention have been described above, appropriately combining the configurations of the embodiments and examples described above have been planned from the beginning.

The embodiments and example that have been disclosed this time are examples in all respects and should be considered to be not restrictive. The scope of the present invention is indicated not by the embodiments and examples described above but by the claims, and intended to include meaning equivalent to the claims, and all modifications within the scope.

### REFERENCE SIGNS LIST

1: drill, 2: cutting edge portion, 21: drill bit tip end portion, 22: drill bit main body portion, 3: shank, 10: rod, 11: first rod section, 12: second rod section, 13: third rod section, 14: fourth rod section, 15: fifth rod section

1. A rod comprising:
a first rod section occupying a predetermined region in a longitudinal direction; and
a second rod section occupying a region different from the first rod section in the longitudinal direction,
wherein
the first rod section has composition including A% by mass of cobalt, 0 to 1% by mass of chromium, 0 to 0.5% by mass of vanadium, and remainder of tungsten carbide and unavoidable impurities,
the second rod section has composition including B% by mass of cobalt, 0 to 1% by mass of chromium, 0 to 0.5% by mass of vanadium, and remainder of tungsten carbide and unavoidable impurities,
contents of cobalt in the first rod section and the second rod section satisfy a relationship of 1% by mass≤B<≤20% by mass,
the first rod section and the second rod section each include greater than or equal to 0.1% by mass of at least one of chromium and vanadium, and
the second rod section has a length of 10 to 1000% with respect to the first rod section in the longitudinal direction.

2. The rod according to claim 1, wherein in each of the first rod section and the second rod section, a total amount of chromium and vanadium is 0.2 to 1.5% by mass.

3. The rod according to claim 1 or 2, further comprising:
a third rod section; and
a fourth rod section,
wherein
the third rod section includes cobalt, chromium, vanadium, tungsten carbide, and unavoidable impurities, an average particle diameter of tungsten carbide in the third rod section is X μm,
the fourth rod section includes cobalt, chromium, vanadium, tungsten carbide, and unavoidable impurities, an average particle diameter of tungsten carbide in the fourth rod section is Y μm,
in the third rod section and the fourth rod section, the average particle diameters of tungsten carbide satisfy a relationship of X≤Y,
the third rod section occupies a region that partially or entirely overlaps the first rod section in the longitudinal direction,
the fourth rod section occupies a region that partially or entirely overlaps the second rod section in the longitudinal direction, and
the fourth rod section has a length of 10 to 1000% with respect to the third rod section in the longitudinal direction.

4. The rod according to claim 3, further comprising a fifth rod section occupying a predetermined region between the first rod section and the second rod section in the longitudinal direction,
wherein
the fifth rod section has composition including C% by mass of cobalt, 0 to 1% by mass of chromium, 0 to 0.5% by mass of vanadium, and remainder of tungsten carbide and unavoidable impurities,
a content of cobalt in the fifth rod section satisfies a relationship of A≥C or C≥B,
the fifth rod section includes greater than or equal to 0.1% by mass of at least one of chromium and vanadium, and
the fifth rod section occupies a region that overlaps both or either one of the third rod section and the fourth rod section in the longitudinal direction.

5. A drill bit body including the rod according to claim 1,
wherein
the drill bit body has a length of 0.5 to 15 mm, and has a maximum diameter in a cross section perpendicular to the longitudinal direction of 0.03 to 3.175 mm, and
the second rod section occupies a tip end of the drill bit body.

6. The drill bit body according to claim 5, wherein the drill bit body satisfies a relationship of 0.05R≤r≤0.6R when R represents the maximum diameter and r represents a web thickness in the cross section.

7. A rod manufacturing method for manufacturing the rod according to claim 1, the method comprising:
a first step of preparing first powder having composition including A% by mass of cobalt, 0 to 1% by mass of chromium, 0 to 0.5% by mass of vanadium, and remainder of tungsten carbide and unavoidable impurities and second powder having composition including B% by mass of cobalt, 0 to 1% by mass of chromium, 0 to 0.5% by mass of vanadium, and remainder of tungsten carbide and unavoidable impurities;
a second step of charging the first powder into a mold and pressing the first powder with a first pressure; and
a third step of charging the second powder into the mold and pressing the second powder with a second pressure equal to or lower than the first pressure,
wherein
contents of cobalt in the first powder and the second powder satisfy a relationship of 1% by mass≤B<≤20% by mass, and
the first powder and the second powder each include greater than or equal to 0.1% by mass of at least one of chromium and vanadium.

8. The rod manufacturing method according to claim 7, wherein in each of the first powder and the second powder, a total amount of chromium and vanadium is 0.2 to 1.5% by mass.

9. The rod manufacturing method according to claim 7, further comprising:
a fourth step of preparing third powder having composition including C% by mass of cobalt, 0 to 1% by mass of chromium, 0 to 0.5% by mass of vanadium, and remainder of tungsten carbide and unavoidable impurities; and
a fifth step of charging the third powder into the mold and pressing the third powder with a third pressure equal to or lower than the first pressure and equal to or higher than the second pressure,
wherein
a content of cobalt in the third powder satisfies a relationship of A≥C or C≥B, and
the third powder includes greater than or equal to 0.1% by mass of at least one of chromiu and vanadium.

10. A drill manufacturing method for manufacturing a drill by using the rod according to claim 1, the method comprising:
an α step of determining a central axis by cutting the rod; and
a β step of defining a groove on the rod with reference to the central axis.

11. The drill manufacturing method according to claim 10, further comprising a y step of attaching a shank to the rod before the α step.

12. A drill bit body comprising:
a first rod section occupying a predetermined region in a longitudinal direction; and
a second rod section occupying a region different from the first rod section in the longitudinal direction,
wherein
the first rod section has composition including A% by mass of cobalt, 0 to 1% by mass of chromium, 0 to 0.5% by mass of vanadium, and remainder of tungsten carbide and unavoidable impurities,
the second rod section has composition including B% by mass of cobalt, 0 to 1% by mass of chromium, 0 to 0.5% by mass of vanadium, and remainder of tungsten carbide and unavoidable impurities,
contents of cobalt in the first rod section and the second rod section satisfy a relationship of 3% by mass≤B<A<13% by mass and B/A≤0.9,
the first rod section and the second rod section each include greater than or equal to 0.1% by mass of at least one of chromium and vanadium, and each include 0.4 to 1.3% by mass of chromium and vanadium in total,
the second rod section has a length of 10 to 1000% with respect to the first rod section in the longitudinal direction,
the drill bit body further comprises a third rod section and a fourth rod section,
the third rod section includes cobalt, chromium, vanadium, tungsten carbide, and unavoidable impurities, and an average particle diameter of tungsten carbide in the third rod section is X μm,
the fourth rod section includes cobalt, chromium, vanadium, tungsten carbide, and unavoidable impurities, and an average particle diameter of tungsten carbide in the fourth rod section is Y μm,
in the third rod section and the fourth rod section, the average particle diameters of tungsten carbide satisfy a relationship of X<Y and Y/X≥1,4,
the third rod section occupies a region that partially or entirely overlaps the first rod section in the longitudinal direction,
the fourth rod section occupies a region that partially or entirely overlaps the second rod section in the longitudinal direction,
the fourth rod section has a length of 10 to 1000% with respect to the third rod section in the longitudinal direction,
the drill bit body has a length of 0.5 to 15 mm, and has a maximum diameter in a cross section perpendicular to the longitudinal direction of 0.03 to 3.175 mm,
the second rod section occupies a tip end of the drill bit body, and
the drill bit body satisfies a relationship of 0.1R≥r≥0.5R when R represents the maximum diameter and r represents a web thickness in the cross section.
